(19) United States
(12) Patent Application Publication
(10) Pub. No.: US 2011/0001875 A1
(43) Pub. Date: Jan. 6, 2011

(54) VIDEO PROCESSING DEVICE

(75) Inventor: Hirotaka Nakayama, Kanagawa (JP)

Correspondence Address: MCDERMOTT WILL & EMERY LLP, 600 13TH STREET, NW, WASHINGTON, DC, 20005-3096, US

(73) Assignee: Panasonic Corporation, Osaka (JP)

(21) Appl. No.: 12/882,659

(22) Filed: Sep. 15, 2010

Related U.S. Application Data
(63) Continuation of application No. PCT/JP2009/000333, filed on Jan. 28, 2009.

(30) Foreign Application Priority Data
Mar. 24, 2008 (JP) 2008-076176

(51) Int. Cl. H04N 7/01

(52) U.S. Cl. 348/448; 348/E07.003

(57) ABSTRACT

When an input video source is a movie source, even then if the input video source contains a lot of noise, pulldown can be accurately detected by controlling a gain of a first noise removal circuit based on a pulldown detected state detected from a frame difference value between an input video signal and its frame-delayed video signal to increase the magnitude of the frame difference, and inserting a comparison threshold for determining whether the frame difference is large or small to a stable position, to improve the detection accuracy of a pulldown detection circuit. Moreover, after interlaced/progressive conversion is performed by an IP conversion circuit, a resultant progressive video signal is processed by a second noise removal circuit so that noise originally contained in the input video signal is removed, resulting in a high-quality output video signal.

### CROSS-REFERENCE TO RELATED APPLICATIONS

This is a continuation of PCT International Application. PCT/JP2009/000333 filed on Jan. 28, 2009, which claims priority to Japanese Patent Application No. 2008-076176 filed on Mar. 24, 2008. The disclosures of these applications including the specifications, the drawings, and the claims are hereby incorporated by reference in their entirety.

### BACKGROUND

The present disclosure relates to video processing devices which, even when an input video signal is a 2:3 pulldown signal and contains a lot of noise, can detect pulldown with high accuracy and simultaneously remove noise contained in the input video signal, thereby obtaining a high-quality output video signal.

Movie (motion picture) sources are obtained by converting film frames having a frame rate of 24 Hz to a 60-Hz video signal which complies with NTSC, using the 2:3 pulldown technique. The 2:3 pulldown input video signal has a feature that the frame difference is zero (small) every five fields. By detecting this sequence (regularity of small →large→large→large→large→small), it is determined that the input source is a movie source. If the 601 input (an interlaced video signal having a rate of 60 fields per second) is converted to a 60 P output (a progressive video signal having a rate of 60 frames per second) (interlaced/progressive conversion), original film frames can be reproduced with high fidelity. Therefore, numerous methods have been proposed for detecting a movie source with high accuracy without failing to detect the regularity of pulldown and falsely determining that an input video signal is of a normal video source.

However, input video signals contain noise no matter whether the signal is digital or analog. In particular, in the case of the analog signal, there is significant noise. Therefore, in order to improve the accuracy of pulldown detection, it is essential to take noise into consideration.

There are methods of detecting the amount of noise itself and changing a pulldown detection technique, depending on the noise amount, in order to correctly handle an input source containing noise (see, for example, Japanese Patent Publication Nos. H11-341444 and 2007-300152).

In Japanese Patent Publication No. H11-341444, a noise detection circuit which detects the noise amount of an input video signal is provided, and the comparison level of film mode detection is controlled, depending on the noise amount.

In Japanese Patent Publication No. 2007-300152, it is determined whether or not an input video signal contains noise, based on the distribution amount of a frame difference of the video signal, and a detection sequence table indicting the presence or absence of noise is changed, thereby performing detection.

### SUMMARY

Japanese Patent Publication Nos. H11-341444 and 2007-300152 are effective when the magnitude of the frame difference of an original source is large. However, there are contents having a small magnitude of frame difference. Therefore, when the amount of noise added to an input video signal is large, it is difficult to determine whether the frame difference is large or small, and therefore, pulldown cannot be detected, i.e., the pulldown detected state is off. In this case, an IP conversion process which is the same as that for normal video signals is performed, resulting in output video which is not smooth and is blurred as a flicker, which is a problem.

If noise removal is performed before pulldown detection, the noise amount of an input video signal is reduced. However, if the gain of the noise removal is excessively increased, the magnitude of the frame difference is conversely reduced, and therefore, it becomes difficult to detect pulldown. Moreover, the noise removal process alters the level of the original source itself, and therefore, smoothness originally possessed by the source is impaired in output video obtained by IP conversion, which is a problem.

The detailed description describes implementations of a video processing device which, even when an original movie source contains a scene having a small magnitude of frame difference and noise is added to the original movie source, detects pulldown with high accuracy, and removes noise contained in an input video signal, thereby obtaining a high-quality video output.

An example video processing device of the present disclosure includes a first noise remover configured to remove noise contained in an input video signal, a pulldown detector configured to determine whether or not the input video signal is of a movie source having the regularity of pulldown, an IP converter configured to convert an interlaced signal which is the input video signal to a progressive signal in a mode corresponding to a result of the determination performed by the pulldown detector, and a second noise remover configured to remove noise from the progressive signal. The first noise remover increases a gain of the noise removal for a specific field at predetermined intervals, depending on a state of the pulldown detection.

The second noise remover performs the noise removal based on a result of the pulldown detection.

According to the present disclosure, the effect of noise removal is enhanced at timings when a frame difference is zero to increase the magnitude of the frame difference, and the sequence of pulldown is detected using a stable comparison threshold. As a result, even when an original movie source has a scene originally having a small frame difference and contains a lot of noise, the pulldown state can be detected with high accuracy.

Moreover, according to the present disclosure, after the pulldown detection is performed with high accuracy, IP conversion is performed, and thereafter, remaining noise can also be removed, resulting in a high-quality output video signal.

### BRIEF DESCRIPTION OF THE DRAWINGS

FIG. 1 is a block diagram showing an overall configuration of a video processing device according to an embodiment of the present disclosure.

FIG. 2 is a diagram showing timings of a 2:3 pulldown input video signal, and a relationship between frame differences and a noise removal gain control method.

FIG. 3 is a diagram showing a relationship between frame difference cumulative values and times of fields when an input video signal is of a movie source.

FIG. 4 is a diagram showing frame difference cumulative values and a control of a magnitude comparison threshold when an input video signal is of a movie source.

FIG. 5 is a diagram showing a control of a gain of a first noise removal circuit of FIG. 1, depending on a detected state of a pulldown sequence.

FIG. 6 is a block diagram showing a detailed configuration of the first noise removal circuit of FIG. 1.

FIG. 7 is a block diagram showing a detailed configuration of a pulldown detection circuit of FIG. 1.

### DETAILED DESCRIPTION

An embodiment of the present disclosure will be described hereinafter with reference to the accompanying drawings.

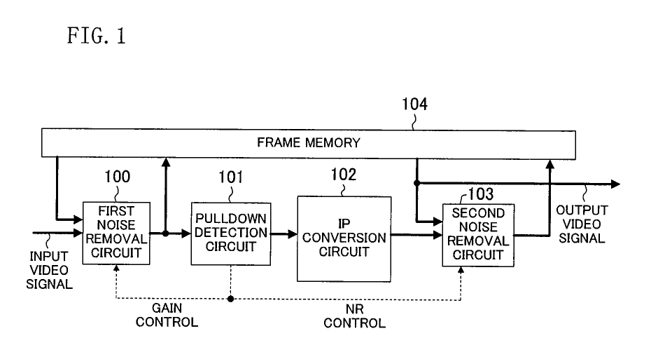

FIG. 1 is a diagram showing an overall configuration of a video processing device according to the embodiment of the present disclosure. The video processing device of FIG. 1 includes a first noise removal circuit 100, a pulldown detection circuit 101, an IP conversion circuit 102, a second noise removal circuit 103, and a frame memory 104.

As shown in FIG. 6, the first noise removal circuit 100 is of the recursive noise reduction type. The first noise removal circuit 100 is configured to calculate a difference between an input video signal IN from the outside and a video signal DLY delayed by the frame memory 104, multiply the difference value by a K value generated by a K value generator 200, and add the resultant product to the input video signal IN to obtain an output signal OUT, thereby removing noise.

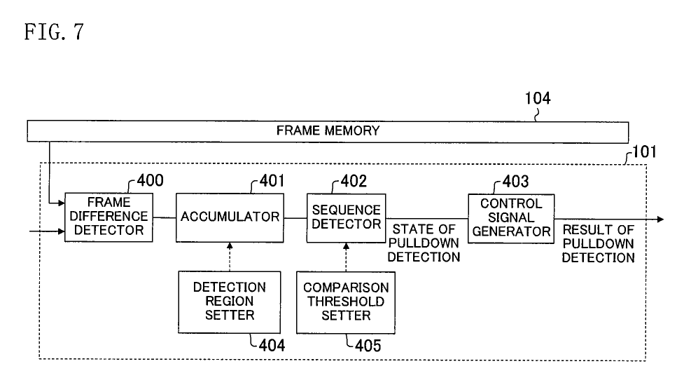

As shown in FIG. 7, the pulldown detection circuit 101 includes a frame difference detector 400 which calculates a difference between an output signal of the first noise removal circuit 100 and a video signal delayed by the frame memory 104, on a pixel-by-pixel basis, an accumulator 401 which accumulates results of the frame difference detector 400 in a region whose position on a screen is set by a detection region setter 404, a sequence detector 402 which detects a pulldown sequence (a pattern of the magnitudes of frame differences) from the results accumulated in the accumulator 401, on a field-by-field basis, based on a set value in a comparison threshold setter 405 which generates a threshold for determining whether a frame difference is large or small, and a control signal generator 403 which generates a signal for controlling the insertion mode of IP conversion based on the pulldown detected state of the sequence detector 402.

The IP conversion circuit 102 is configured to switch between a motion adaptive IP conversion mode for normal video sources and a movie source insertion IP conversion mode for movie sources, based on the result of pulldown detection performed by the pulldown detection circuit 101, to convert an input interlaced signal to a progressive signal.

The second noise removal circuit 103 is configured to, when the result of pulldown detection performed by the pulldown detection circuit 101 indicates a movie source, pass an output video signal of the IP conversion circuit 102 to a circuit which performs recursive noise removal using a delayed signal from the frame memory 104, and when the pulldown detection result indicates a normal video source, directly output the output video signal of the IP conversion circuit 102 without performing noise removal.

The frame memory 104 is configured to delay an input video signal on a field-by-field basis and output the resultant video signal.

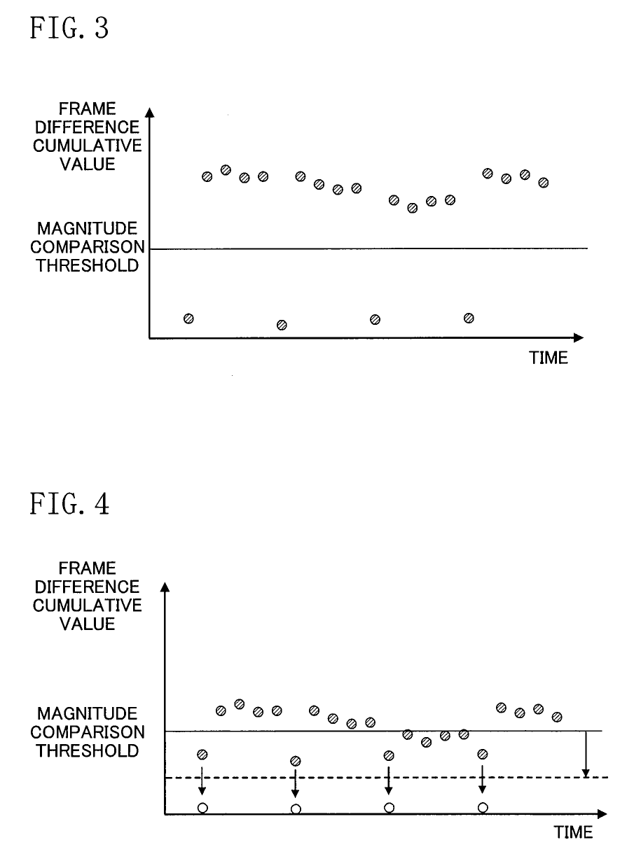

A control method will be described which allows pulldown detection when the input video signal contains a scene having small frame differences as shown in FIG. 4, rather than a scene having large frame differences as shown in FIG. 3, based on the detection result of the pulldown detection circuit 101.

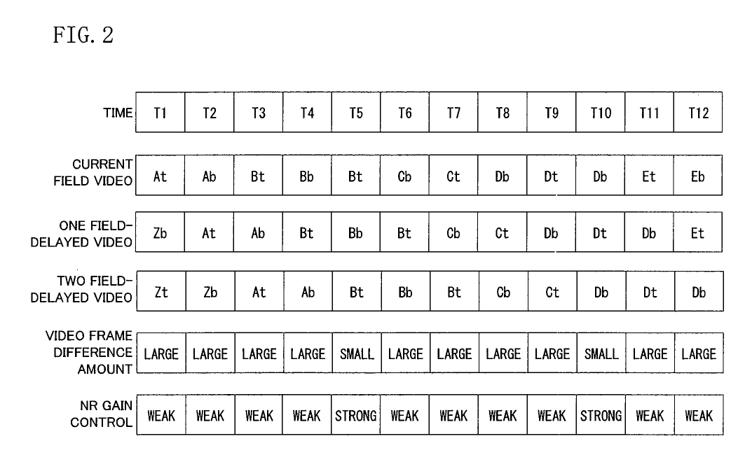

FIG. 2 shows timings of a 2:3 pulldown input video signal, and a relationship between frame differences and the noise removal gain control method. In current field video, At, Bt, Ct, Dt, and Et each indicate a top field, and Ab, Bb, Cb, Db, and Eb each indicate a bottom field. In two field-delayed video, Zt indicates a top field, and Zb indicates a bottom field.

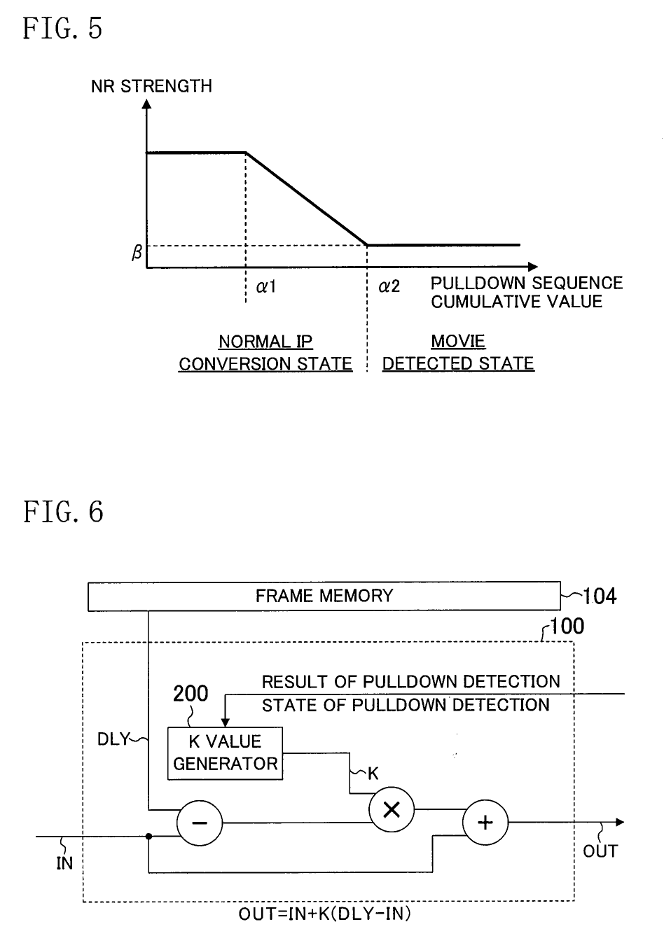

When the input source is a movie source, there is a feature that a zero (small) frame difference occurs every five fields as shown in the timing chart of FIG. 2 indicating frame differences at field times T1-T12. Specifically, a zero (small) frame difference occurs at times T5 and T10. At times T5 and T10 the frame difference between the input video signal and the frame delayed video signal is not zero because of the presence of noise. While a noise removal gain (NR gain) of the first noise removal circuit 100 is set to be large at times T5 and T10, the noise removal gain is set to be small at the other times (β in FIG. 5). In this case, by switching the K value generator 200 which normally generates the K value based on a motion or an edge state of an image with respect to a video signal, to the gain control of the pulldown detected state, noise components of the input signals at T5 and T10 are removed, and the difference cumulative value of small frame differences in the pulldown detection circuit 101 is smaller than when the gain is intentionally increased, resulting in frame differences having a greater magnitude (FIG. 4). In addition to the increase in the difference magnitude, by setting a magnitude comparison threshold set in the comparison threshold setter 405 to be at an appropriate position, the large/small sequence of pulldown is detected without an error, and the movie insertion IP conversion mode is selected in the IP conversion circuit 102, resulting in a high-quality video output.

In the present disclosure, a plurality of noise removal circuits (e.g., the first and second noise removal circuits 100 and 103) are provided. Different functions are imparted to the noise removal circuits. Specifically, when the input source is a movie source, the first noise removal circuit 100 is used to increase the gain of noise removal for a predetermined specific field to increase the magnitude of a frame difference, thereby increasing the accuracy of pulldown detection, and the second noise removal circuit 103 is used to mainly remove remaining noise contained in a remaining time (large frame differences) based on the result of detection performed by the pulldown detection circuit 101.

Moreover, in the gain control of the first noise removal circuit 100, in order not to impair the quality of the output movie video signal when the input video signal is switched from a normal video source to a movie source, and pulldown is then detected, the control mode may be switched to a changing mode in which the gain is decreased with an increase in the sequence cumulative value (an increase in the probability that the input source is a movie source) as shown in FIG. 5. According to FIG. 5, when the sequence cumulative value of pulldown (horizontal axis) is within the range of 0 to α2, the normal IP conversion is performed. Note that, when the sequence cumulative value of pulldown is within the range of α1 to α2, the strength of noise removal is gradually decreased with an increase in the sequence cumulative value. When the sequence cumulative value of pulldown is larger than or equal to α2, a movie detected state is established, and the operation is switched from normal IP conversion to movie IP conversion. Specifically, the strength of noise removal is fixed to the minimum value β. Note that, when the movie detected state is changed back to the video detected state (normal IP conversion state), the control modes of the first and second noise removal circuits 100 and 103 are changed back to control modes for normal video signals.

As described above, in this embodiment, the accuracy of pulldown detection is improved by changing the noise removal modes based on the regularity of pulldown, and noise contained in the input video signal is removed. Therefore, even when the input video signal contains a scene having a small magnitude of frame difference and contains a lot of noise, a high-quality video output can be obtained.

The video processing device of the present disclosure has highly accurate pulldown detection performance and high noise removal performance, and is useful for increasing the image quality of progressive panel displays, such as plasma TVs, liquid crystal TVs, and the like.

What is claimed is:

1. A video processing device comprising:
a first noise remover configured to remove noise contained in an input video signal;
a pulldown detector configured to determine whether or not the input video signal is of a movie source having the regularity of pulldown;
an IP converter configured to convert an interlaced signal which is the input video signal to a progressive signal in a mode corresponding to a result of the determination performed by the pulldown detector; and
a second noise remover configured to remove noise from the progressive signal, wherein
the first noise remover increases a gain of the noise removal for a specific field at predetermined intervals, depending on a state of the pulldown detection.

2. The video processing device of claim 1, wherein
the second noise remover performs the noise removal based on a result of the pulldown detection.

3. The video processing device of claim 1, wherein
the pulldown detector accurately performs the pulldown detection by changing a comparison threshold while a magnitude of a frame difference of the input video signal is increased.

4. The video processing device of claim 1, wherein
modes of the noise removal are selected, depending on whether the input video signal is of a movie source or of a normal video source.

5. A video processing method comprising:
a first noise removal step of removing noise contained in an input video signal;
a pulldown detection step of determining whether or not the input video signal is of a movie source having the regularity of pulldown;
an IP conversion step of converting an interlaced signal which is the input video signal to a progressive signal in a mode corresponding to a result of the determination performed by the pulldown detection step; and
a second noise removal step of removing noise from the progressive signal, wherein
the first noise removal step includes a step of increasing a gain of the noise removal for a specific field at predetermined intervals, depending on a state of the pulldown detection.
